(19) United States
(12) Patent Application Publication
(10) Pub. No.: US 2011/0236165 A1
(43) Pub. Date: Sep. 29, 2011

(54) RACK TRAY, RACK, AND RACK TRANSPORT SYSTEM

(75) Inventor: Masahiro Kaiga, Shizuoka (JP)

(73) Assignee: Beckman Coulter, Inc., Brea, CA (US)

(21) Appl. No.: 13/133,646

(22) PCT Filed: Mar. 23, 2009
(86) PCT No.: PCT/JP2009/055608

§ 371 Date: Jun. 8, 2011

(30) Foreign Application Priority Data
Dec. 11, 2008 (JP) 2008-315939

(51) Int. Cl. A47B 81/00; B65G 49/00

(52) U.S. Cl. 414/222.07; 211/71.01

(57) ABSTRACT

A rack tray, a rack, and a rack transport system that can safely perform transport and setting in an apparatus with a plurality of racks supporting a plurality of specimen containers arranged are provided. For this purpose, it comprises a rack dropout-preventing mechanism (10b) preventing the rack (9) from being dropped out of an rack tray (10) opening when a rack (9) is stored on a tray base (10a); a rack movement-preventing mechanism (10c) preventing the plurality of racks (9) arranged on a tray base (10a) from moving and falling; and a guide rail (10e) having a plurality of engagement sections (10h) at positions corresponding to the number of racks held and stored on the tray base (10a). The rack movement-preventing mechanism (10c) comprises a projection (10p) and the projection (10p) is engaged with an engagement section (10h) to lock the backward direction movement of a rack tray opening.

### TECHNICAL FIELD

The present invention relates to a rack tray that holds a plurality of racks and is placed on an automatic analyzing apparatus, a rack, and a rack transport system using the rack tray.

### BACKGROUND ART

In the past, when a dispenser or an automatic analyzing apparatus supplies or collects a specimen, a rack tray that can arrange and hold a plurality of racks supporting a plurality of specimen containers is used (for example, see Patent References 1 and 2).

Patent Reference 1: Japanese Laid-Open Publication No. 10-123146

Patent Reference 2: Japanese Laid-Open Publication No. 2002-90378

### DISCLOSURE OF THE INVENTION

### Problems to be Solved by the Invention

However, in a rack tray disclosed in Patent Reference 1, a T-shaped projection is formed on an upper surface of a rack tray and fitted in a T-shaped trench of a lower section of the rack to obtain a fall prevention mechanism of the rack. However, a rack slips on the rack tray and is brought into contact with an end of the rack tray to probably cause a specimen to fly in all directions for example when the rack tray is tilted by transport. Since a rack is fitted on the T-shaped projection of the tray, the rack is not easily set, and a long time and a lot of trouble are required to arrange a plurality of racks. Furthermore, since a rack cannot be taken out of only the endmost rack of the plurality of arranged racks, some middle rack cannot be taken out without a problem.

Since a rack tray disclosed in Patent Document 2 transports a rack along a guide rail and attaches/detaches the rack by using a narrow oblique section arranged in the middle of the guide rail, racks cannot be set only one by one. Since racks cannot be easily set, a long time and a lot of trouble are required to arrange a plurality of racks to make it impossible to easily set the racks at desired positions.

The present invention has been made in consideration of the above description and has as its object to provide a rack tray that, when a plurality of racks supporting a plurality of specimen containers are arranged, can safely transport the racks and set the racks in an apparatus, a rack, and a rack transport system.

### Means for Solving the Problem

In order to solve the abovementioned problem and to achieve the object, a rack tray according to the present invention is a rack tray that arranges and holds a plurality of racks supporting a plurality of specimen containers, and is characterized by comprising: a tray base that stores the plurality of racks; a rack dropout-preventing mechanism that projects from an opening of the rack tray to prevent the racks from being dropped out when the racks are stored on the tray base; and a rack movement-preventing mechanism that moves on the tray base to press the plurality of racks arranged on the tray base to a side of the rack dropout-preventing mechanism.

The rack tray according to the present invention, in the above invention, is characterized by comprising a guide rail having a plurality of engagement sections at positions corresponding to the number of racks held and stored on the tray base, and a locking section held by the rack movement-preventing mechanism is engaged with the engagement section to lock the movement of the rack.

The rack tray according to the present invention, in the above invention, is characterized in that the engagement section is a projection formed on the guide rail, an inclination of a slope on a side of the rack tray opening is set to be high, and an inclination of the other slope is to be low.

The rack tray according to the present invention, in the above invention, is characterized in that the rack movement-preventing mechanism includes a handle section that pushes up the locking section, the handle section is gripped and pushed to push up the locking section to cancel the engagement with the engagement section, and the rack movement-preventing mechanism is moved.

The rack tray according to the present invention, in the above invention, is characterized by comprising grip members on two opposite sides parallel to an arrangement direction of the racks stored on the tray base.

The rack tray according to the present invention, in the above invention, is characterized in that the rack movement-preventing mechanism includes a shaft supported by the handle section and extending to a lower section of the guide rail, and the guide rail includes a trench section through which the shaft passes with movement of the rack movement-preventing mechanism.

The rack tray according to the present invention, in the above invention, is characterized in that the guide rail is formed independently of the tray base, jointed to the tray base by a joint member, and a spring that biases to push up the guide rail is arranged between the joint member and the guide rail.

The rack tray according to the present invention, in the above invention, is characterized in that the tray base includes guide walls on three sides except for the opening in the rack traveling direction, and the guide wall of any one of two sides parallel to the traveling direction has a fitting section fitted on the rack formed on a side surface thereof.

The rack tray according to the present invention, in the above invention, is characterized in that a rack having a projection section that is fitted in the fitting section of the guide wall is held and stored.

The rack tray according to the present invention, in the above invention, is characterized in that the grip member arranged on the opening side of the rack in the traveling direction is arranged such that the holding section is offset from an arrangement position of the grip member.

A rack transport system according to the present invention includes: a rack tray set section on which a rack tray that arranges and holds the plurality of racks supporting a plurality of specimen containers and described in anyone of the above is placed; a rack collecting section on which an empty rack tray according to anyone of the above is placed and which collects a rack supporting a plurality of specimen containers that are dispensed; and a transport mechanism that transports the rack from the rack tray set section to a dispensing mechanism, dispenses specimens from all the specimen containers, and thereafter transports the rack to the rack collecting section.

The rack transport system according to the present invention, in the above invention, is characterized in that the rack collecting section includes a lock canceling mechanism of a rack movement-preventing mechanism of the rack tray.

The rack transport system according to the present invention, in the above invention, is characterized in that the lock canceling mechanism is a push-up member that pushes up a shaft of the rack tray.

The rack transport system according to the present invention, in the above invention, is characterized in that the lock canceling mechanism is a push-up member that pushes up a joint member of the rack tray such that the guide rail of the rack tray is pushed down.

The rack transport system according to the present invention, in the above invention, is characterized in that the rack tray set section and the rack collecting section include a lock canceling mechanism of a rack dropout-preventing mechanism of the rack tray.

The rack according to the present invention is a rack that holds and stores the rack tray according to any one of the above, characterized by comprising a projection section that is fitted in a fitting section of a guide wall of a tray base.

### Effect of the Invention

According to the present invention, an engagement section is formed on a guide rail, and a locking section of a rack movement-preventing mechanism is engaged with the engagement section to lock the movement of a rack, thereby achieving the effect that transport of a rack tray on which a plurality of racks are arranged and setting of the rack tray in an apparatus can be safely performed.

### BRIEF DESCRIPTION OF THE DRAWINGS

FIG. 1 is a pattern diagram showing a main part configuration of an automatic analyzing apparatus using a rack tray according to Embodiment 1.

FIG. 2 is a perspective view of a rack tray according to Embodiment 1.

FIG. 3 is a perspective view of a rack tray that stores racks holding specimen containers.

FIG. 4 is a sectional view of the rack tray shown in FIG. 3 along an A-A line.

FIG. 5-1 is an operational diagram of a rack movement-preventing mechanism according to Embodiment 1.

FIG. 5-2 is an operational diagram of a rack movement-preventing mechanism according to Embodiment 1.

FIG. 6 is a cross-sectional view of an engagement section including the rack movement-preventing mechanism and a guide rail according to Embodiment 1.

FIG. 7 is a perspective view of a rack collecting section according to Embodiment 1.

FIG. 8-1 is an operational diagram of lock cancellation of the rack movement-preventing mechanism according to Embodiment 1.

FIG. 8-2 is an operational diagram of lock cancellation of the rack movement-preventing mechanism according to Embodiment 1.

FIG. 9 is a sectional view of the rack tray shown in FIG. 3 along a B-B line.

FIG. 10 is a perspective view of a rack tray set section according to Embodiment 1.

FIG. 11-1 is an operational diagram of lock cancellation of a rack dropout-preventing mechanism according to Embodiment 1.

FIG. 11-2 is an operational diagram of lock cancellation of the rack dropout-preventing mechanism according to Embodiment 1.

FIG. 12-1 is a front view showing a modification of a rack tray according to Embodiment 1.

FIG. 12-2 is a pattern diagram showing a main part configuration of an automatic analyzing apparatus using a rack tray according to a modification of Embodiment 1.

FIG. 13 is a sectional view showing another modification of the rack tray according to Embodiment 1 together with a rack and a rack collecting section.

FIG. 14 is a cross-sectional view of an engagement section including a rack movement-preventing mechanism and a guide rail according to Embodiment 2.

FIG. 15-1 is a sectional view showing a rack tray according to Embodiment 2 together with a rack and a rack collecting section.

FIG. 15-2 is a sectional view showing a rack tray according to Embodiment 2 together with a rack and a rack collecting section.

1, 1A Automatic analyzing apparatus

2, 3 First and second reagent storage

2a, 3a Reagent container

4 Reaction table

4a Holding section

4b Optical path

5 Reaction container

6, 7 First and second reagent dispenser

6a, 7a Arm

6b, 7b Probe

8, 8′ Rack transport system

8a Push-out lever

8A Rack tray set section

8B, 8B′ Transport mechanism

8C Rack collecting section

9 Rack

9a Specimen container

10, 10A, 10B, 10C Rack tray

10a Tray base

10b Rack dropout-preventing mechanism

10c, 10c′, 10c″ Rack movement-preventing mechanism

10d Grip member

10e, 10e′ Guide rail

10f Guide wall

10g Substrate

10h, 61 Engagement section

10i, 10j Trench

10k, 10l Partition

10m, 10r, 33 Spring

10n, 10q, 32 Shaft

10o E ring

10p, 60 Projection

10s Dropout-preventing lever

10t, 10t′, 10u Push-up section

10w Hole

11 Analytical optical system

12 Cleaning mechanism

13, 14 First and second stirring device

15 Control section

16 Input section

17 Analyzing section

18 Memory section

19 Output section

20 Specimen dispenser

30 Joint member

31 Joint section

40 Measuring mechanism

50 Control mechanism

### BEST MODE FOR CARRYING OUT THE INVENTION

With reference to the accompanying drawings, a rack tray, a rack, and a rack transport system according to embodiments of the present invention will be described below by using, as an example, an automatic analyzing apparatus that analyzes a liquid specimen such as blood as a sample. Drawings referred to in the following explanation are typical. When the same object is shown in different drawings, dimensions, scales and the like of the object may be different from each other. The invention is not limited to the embodiments. In the drawings, the same parts are denoted by the same reference numerals.

### Embodiment 1

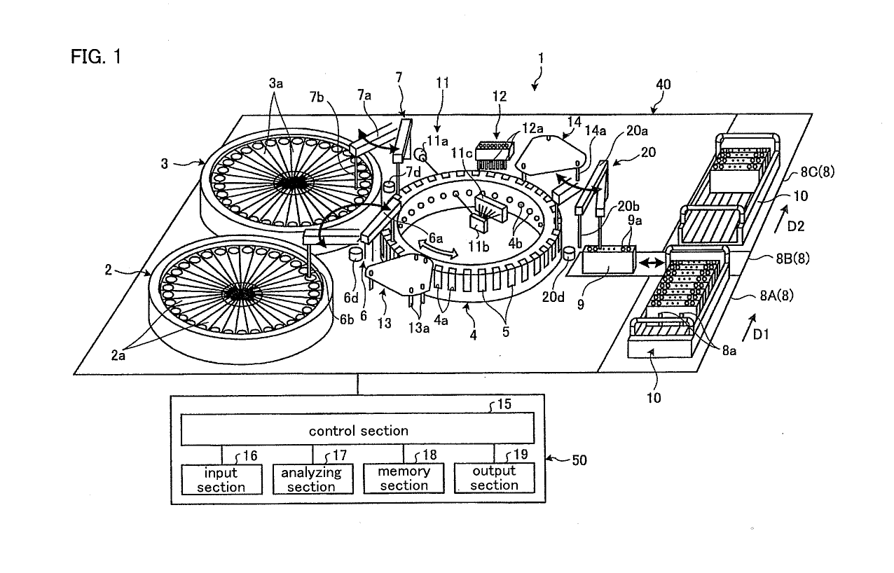

FIG. 1 is a pattern diagram showing a configuration of an automatic analyzing apparatus 1 using a rack tray 10 and a rack transport system 8 according to Embodiment 1. As shown in FIG. 1, the automatic analyzing apparatus 1 includes a measuring mechanism 40 that dispenses a specimen to be analyzed and a reagent into reaction containers 5, respectively, and optically measures reactions occurring in the reaction containers 5 into which the specimen and the reagent are dispersed, and a control mechanism 50 that controls the entire automatic analyzing apparatus 1 including the measuring mechanism 40 and analyzes measurement results in the measuring mechanism 40. The automatic analyzing apparatus 1 automatically performs biochemical, immunological, or genetic analysis of a plurality of specimens by the combination of the two mechanisms.

The measuring mechanism 40 includes a first reagent storage 2, a second reagent storage 3, a reaction table 4, a first reagent dispenser 6, a second reagent dispenser 7, a rack transport system 8, an analytical optical system 11, a cleaning mechanism 12, a first stirring device 13, a second stirring device 14, and a specimen dispenser 20.

In the first reagent storage 2, as shown in FIG. 1, a plurality of reagent containers 2a that store first reagents are arranged in a circumferential direction. The first reagent storage 2 is rotated by driving means (not shown) to transport the reagent containers 2a in the circumferential direction. The plurality of reagent containers 2a are filled with reagents depending on inspection items, respectively. Information recording media (not shown) on which information such as types, lots, and expiration dates of the stored reagents are recorded are stuck on outer surfaces of the reagent containers 2a. In this case, on a periphery of the first reagent storage 2, a reading device (not shown) that reads the reagent information recorded on the information recording medium stuck on the reagent container 2a and outputs the reagent information to the control section 15 is installed. Above the first reagent storage 2, an openable and closable lid (not shown) is arranged to suppress the reagent from being evaporated or transformed. A constant temperature tank (not shown) for cooling reagent is arranged below the first reagent storage 2.

In the second reagent storage 3, as shown in FIG. 1, a plurality of reagent containers 3a that store second reagents are arranged in a circumferential direction. Like the first reagent storage 2, the second reagent storage 3 is rotated by driving means (not shown) to transport the reagent containers 3a in the circumferential direction. The plurality of reagent containers 3a are filled with reagents depending on inspection items, respectively. Information recording media (not shown) on which information such as types, lots, and expiration dates of the stored reagents are recorded are stuck on outer surfaces of the reagent containers 3a. In this case, on a periphery of the second reagent storage 3, a reading device (not shown) that reads the reagent information recorded on the information recording medium stuck on the reagent container 3a and outputs the reagent information to the control section 15 is installed. Above the second reagent storage 3, an openable and closable lid (not shown) is arranged to suppress the reagent from being evaporated or transformed. A constant temperature tank (not shown) for cooling reagent is arranged below the second reagent storage 3.

On the reaction table 4, as shown in FIG. 1, a plurality of reaction containers 5 are arranged along a circumferential direction. The reaction table 4 is rotated by driving means (not shown) different from the driving means that drives the first and second reagent storages 2 and 3 in a direction indicated by an arrow to move the reaction container 5 in the circumferential direction. The reaction table 4 is arranged between a light source 11a and an optical splitter 11b and has a holding section 4a that holds the reaction container 5 and an optical path 4b formed by a circular opening that guides a beam emitted from the light source 11a to the optical splitter 11b. The holding sections 4a are arranged at predetermined intervals on the periphery of the reaction table 4 along a circumferential direction, and has the optical path 4b radially extending on an inner circumferential side of the holding section 4a formed therein. An openable and closable lid (not shown) is arranged above the reaction table 4, and a constant temperature tank (not shown) to heat to a temperature at which a reaction between a specimen and a reagent is accelerated is arranged below the reaction table 4.

The reaction container 5 is a container, called a cuvette, shaped as a rectangular tube made of an optically transparent material, for example, glass including heat-resistant glass, cyclic olefin, or polystyrene that transmits 80% or more of light included in analytical light (340 to 800 nm) emitted from the analytical optical system 11.

The first reagent dispenser 6 includes an arm 6a that moves vertically and rotates about a vertical line passing through a proximal end of the arm 6a freely. At a distal end of the arm 6a, a probe 6b that sucks and discharges a specimen is attached. The first reagent dispenser 6 includes a breathing mechanism using a breathing syringe or a piezoelectric element (not shown). The first reagent dispenser 6 sucks the first reagent with the probe 6b from the reagent container 2a moved to a predetermined position on the first reagent storage 2 described above, swings the arm 6a in a clockwise direction in the drawing and discharges the first reagent into the reaction container 5 to perform a dispensing operation. A cleaning tank 6d that cleans the probe 6b with cleaning water is installed on a pivotal trace of the probe 6b.

The second reagent dispenser 7 includes an arm 7a that moves vertically and rotates about a vertical line passing through the distal end of the arm 7a freely. At a distal end of the arm 7a, a probe 7b that sucks and discharges a specimen is attached. The second reagent dispenser 7 includes a breathing mechanism using a breathing syringe or a piezoelectric element (not shown). The second reagent dispenser 7 sucks the second reagent with the probe 7b from the reagent container 3a moved to a predetermined position on the second reagent storage 3 described above, swings the arm 7a in a counterclockwise direction in the drawing and discharges the second reagent into the reaction container 5 to perform a dispensing operation. A cleaning tank 7d that cleans the probe 7b with cleaning water is installed on a pivotal trace of the probe 7b.

The analytical optical system 11 is an optical system that causes analysis light (340 to 800 nm) to be transmitted through a liquid sample in the reaction container 5 obtained by a reaction between the reagent and the specimen in order to perform analysis, and has the light source 11a, the optical splitter 11b, and a light-receiving section 11c. The analysis light emitted from the light source 11a transmits through the liquid sample in the reaction container 5 and received by the light-receiving section 11c arranged at a position opposing the optical splitter 11b.

In the first and second stirring devices 13 and 14, stirring rods 13a and 14a stir the dispensed specimen and reagent to cause a uniform reaction.

In the cleaning mechanism 12, a nozzle 12a sucks and discharges a reaction fluid in the reaction container 5 measured by the analytical optical system 11 and pours and sucks a cleaning solution such as a cleaner or a cleaning fluid to perform cleaning. Although the cleaned reaction container 5 is recycled, the reaction container 5 may be discarded depending on inspection of the contents after measurement is performed once.

The specimen dispenser 20 includes an arm 20a that moves vertically and rotates about a vertical line passing through a proximal end of the arm 20a freely. At a distal end of the arm 20a, a probe 20b that sucks and discharges a specimen is attached. The specimen dispenser 20 includes a breathing mechanism using a breathing syringe or a piezoelectric element (not shown). The specimen dispenser 20 sucks the specimen with the probe 20b from the specimen container 9a moved to a dispensing position by the rack transport system 8 (as will be described below), swings the arm 20a in a clockwise direction in the drawing and discharges the specimen into the reaction container 5 to perform a dispensing operation. A cleaning tank 20d that cleans the probe 20b with cleaning water is installed on a pivotal trace of the probe 20b.

The rack transport system 8, as shown in FIG. 1, includes a rack tray set section 8A on which a rack tray 10 in which a plurality of racks 9 supporting a plurality of specimen containers 9a are arranged and held is placed, a rack collecting section 8C on which an empty rack tray 10 is placed and that collects a rack supporting a specimen container the dispensing operation of which is complete, and a transport mechanism 8B that transports the rack 9 which is pushed out of the rack tray set section 8A with a push-out lever 8a to the dispensing position of the specimen dispenser 20 and transports the rack 9 to the rack collecting section 8C after the specimen is dispensed by the specimen dispenser 20 from the specimen container 9a supported by the rack 9.

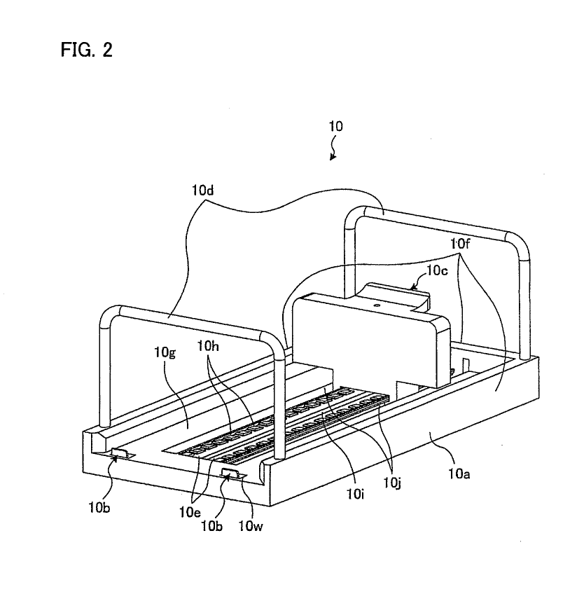

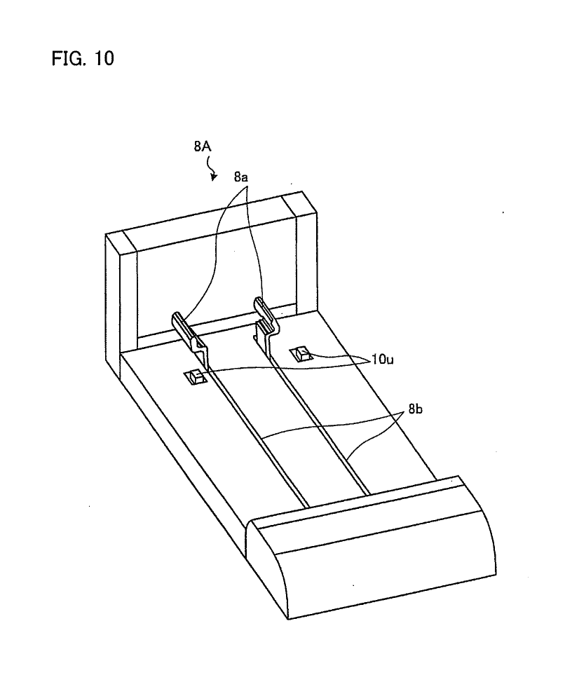

In order to supply the specimen container 9a to the specimen dispenser 20, the rack tray 10 is placed on the rack tray set section 8A, the plurality of racks 9 set in the rack tray 10 by the transport mechanism 8B are transported by the push-out lever 8a in a first direction indicated by an arrow D1 to sequentially send the plurality of racks 9 to the transport mechanism 8B. The push-out lever 8a is transported by transporting means such as a belt conveyor (not shown). The transport mechanism 8B transports the rack 10 sent with the push-out lever 8a to the dispensing position of the specimen dispenser 20 while stepping the rack 10 along the transport mechanism 8B that extends to the specimen dispenser 20. In the rack tray 10 before being arranged in the rack transport system 8, the rack dropout-preventing mechanism 10b projects into the opening of the rack tray 10 to prevent the rack 9 from being dropped out of the opening (see FIG. 2). However, when the rack tray 10 is arranged in the rack tray set section 8A, a rack dropout prevention canceling mechanism 10u (see FIG. 10) on the rack tray set section 8A (will be described below) cancels the lock of the rack dropout-preventing mechanism 10b to make it possible to transport the rack 9 from the opening to the transport mechanism 8B with the push-out lever 8a.

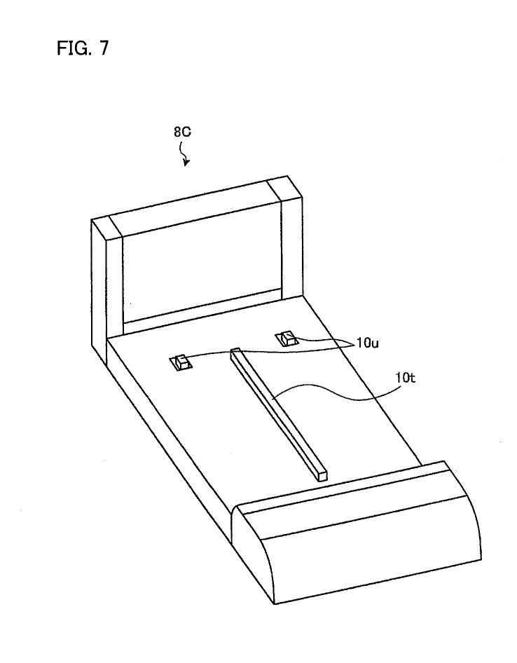

After the specimen is dispensed by the specimen dispenser 20 from the specimen container 9a supported by the rack 9, the transport mechanism 8B transports the rack 9 from the dispensing position of the specimen dispenser 20 to a position opposing the rack collecting section 8C. The rack 9 is pushed out of the transport mechanism 8B to a side of the rack collecting section 8C with a push-out lever (not shown) in a direction indicated by an arrow D2, and the rack 9 is collected by the rack tray 10. Like the rack tray set section 8A, the rack collecting section 8C includes the rack dropout prevention canceling mechanism 10u (see FIG. 7). When the empty rack tray 10 is set in the rack collecting section 8C, the rack dropout-preventing mechanism 10b is unlocked to make it possible to transport the rack 9 from the transport mechanism 8B to the rack collecting section 8C with a push-out lever (not shown).

The control mechanism 50 includes the control section 15, an input section 16, the analyzing section 17, a memory section 18, and an output section 19. The control section 15 is connected to each section included in the measuring mechanism 40 and the control mechanism. As the control section 15, a microcomputer or the like is used to control operations of each section. The control section 15 performs predetermined input/output control about information input/output in/from each constituent part and performs predetermined information processing on the information. The control section 15 controls operations of each section of the automatic analyzing apparatus 1 and, when an expiration date or the like of the reagent is out of a set range on the basis of the information read from the information recording medium, controls the automatic analyzing apparatus 1 to stop an analyzing operation or gives an alarm to an operator. The control section 15 also functions as a transport control section that controls an operation of the rack transport system 8.

The input section 16 is constituted by using a keyboard, a mouse, or the like and acquires various pieces of information required for analysis of a specimen, instruction information of an analyzing operation from the outside. The analyzing section 17 arithmetically operates an absorbance or the like on the basis of a measurement result acquired from the analytical optical system 11 to perform constituent analysis of a specimen or the like. The memory section 18 is configured by using a hard disk that magnetically stores information and a memory that, when the automatic analyzing apparatus 1 executes processing, loads various programs related to that processing from the hard disk and electrically stores the various programs, and stores the various programs to store various pieces of information including an analysis result of the specimen or the like. The memory section 18 may include an auxiliary memory device that can read information stored in a storage medium such as a CD-ROM, a DVD-ROM, or a PC card. The output section 19 is configured by using a printer, a communication mechanism, or the like, and outputs various pieces of information including an analysis result of the specimen to notify a user.

In the automatic analyzing apparatus 1 configured as described above, after the first reagent dispenser 6 dispenses a first reagent in the reagent container 2a to the plurality of reaction containers 5 sequentially transported in line, the specimen dispenser 20 dispenses the specimen in the specimen container 9a, the second reagent dispenser 7 dispenses a second reagent in the reagent container 3a, and the analytical optical system 11 measures a spectroscopic intensity of a sample obtained by a reaction between a specimen and a reagent. The measurement result is analyzed by the analyzing section 17 to automatically perform constituent analysis of the specimen or the like. The reaction container 5 that is transported after completion of the measurement by the analytical optical system 11 is cleaned by the cleaning mechanism 12 while the reaction container 5 is being transported, thereby a series of analyzing operations are continuously repeated.

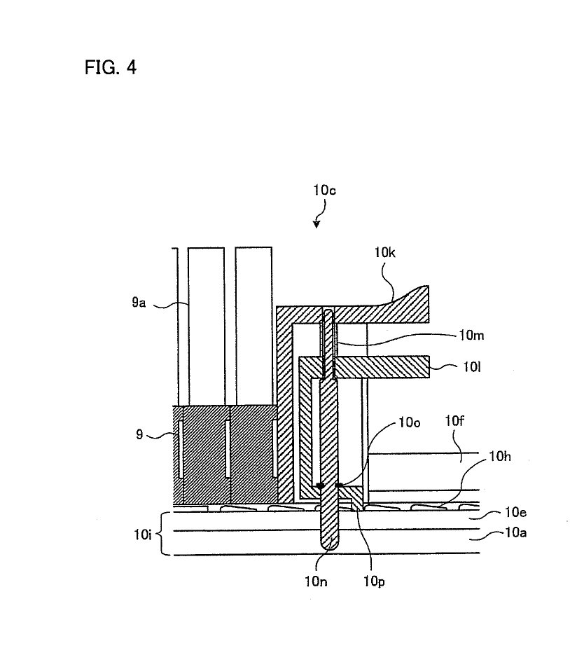

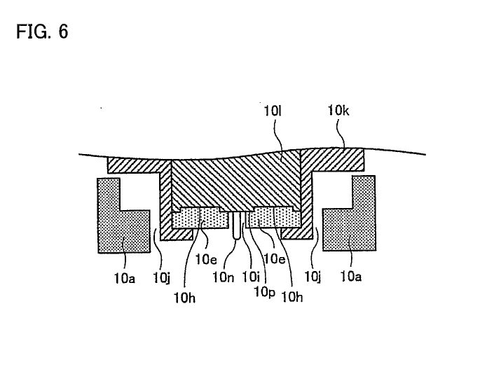

The rack tray 10 according to Embodiment 1 will be described below in detail with reference to FIG. 2. FIG. 2 is a perspective view of the rack tray 10 according to Embodiment 1. The rack tray 10 roughly includes a tray base 10a, a rack dropout-preventing mechanism 10b, a rack movement-preventing mechanism 10c, a grip member 10d, and a guide rail 10e. The tray base 10a has a substrate 10g supporting the rack 9, and guide walls 10f are arranged on three sides of the substrate 10g. The rack tray 10 has an opening in a side where the guide wall 10f is not formed, the rack dropout-preventing mechanism 10b projects into the opening to prevent the plurality of racks 9 stored on the tray base 10a from being dropped out from the opening. The grip members 10d are arranged on the opening and the guide wall 10f on the side opposing the opening, and a holding section of the grip member 10d is gripped to transport the rack tray 10. The grip member 10d shown in FIG. 2 vertically rises from the guide wall 10f and bends at the holding section to form an inverted U-shape. However, the grip member 10d arranged on the opening may have a bent section that can be horizontally bent outside the tray base 10a in the middle of a vertically rising pipe to make it possible to offset the holding section outside the rack tray 10. The grip member 10d is offset to make it easy to take in/out the rack 9. The guide rail 10e, in Embodiment 1, is integrated with the tray base 10a and formed in parallel to the traveling direction of the arranged and held racks 10. There is a trench 10i at a center section of the guide rail 10e and the trench 10i is provided for a shaft (as will be described later) to travel. On an upper surface of the guide rail 10e, a plurality of engagement sections 10h are formed at positions corresponding to the number of racks to be stored. The rack movement-preventing mechanism 10c is supported by the guide rail 10e by sandwiching the guide rail 10e from a side of a trench 10j (see FIG. 6). A projection 10p (see FIG. 4) serving as a locking section of the rack movement-preventing mechanism 10c (will be described later) is engaged with the engagement section 10h formed on the guide rail 10e to lock the rack movement-preventing mechanism 10c. In this manner, the held rack 9 is prevented from moving.

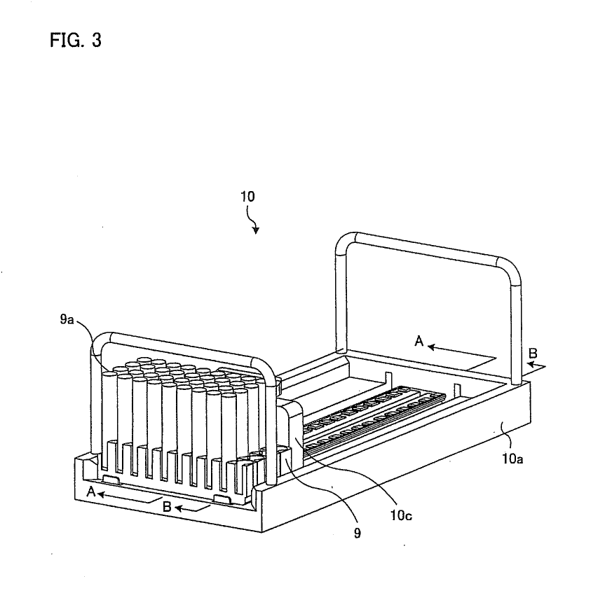

The rack movement-preventing mechanism 10c will be described below with reference to the drawing. FIG. 3 is a perspective view of the rack tray 10 in which the rack 9 holding the specimen container 9a is stored. FIG. 4 is a sectional view of the rack tray 10 in FIG. 3 along an A-A line. FIGS. 5-1 and 5-2 are operational diagrams of the rack movement-preventing mechanism 10c. FIG. 6 is a cross-sectional view of the engagement section including the rack movement-preventing mechanism 10c and the guide rail 10e.

As shown in FIG. 3, the racks 9 holding the specimen containers 9a are arranged in the tray base 10a of the rack tray 10 in parallel from the opening and pushed on the opening side by the rack movement-preventing mechanism 10c to prevent the rack 9 from moving and falling. As shown in FIG. 4, the rack movement-preventing mechanism 10c has a handle section including a partition 10k and a partition 10l, a push spring 10m is arranged between the partition 10k and the partition 10l to bias the partition 10l downward. The projection 10p is formed at a distal end of the partition 10l. The projection 10p is engaged between the plurality of engagement sections 10h arranged on the guide rail 10e at intervals each having a width of the rack 9 as one pitch. A shaft 10n extending to the lower section of the guide rail 10e is supported on the partition 10l, and an E ring 10o is attached between the shaft 10n and the partition 10l. In the movement of the rack movement-preventing mechanism 10c, the shaft 10n moves in the trench 10i formed between the guide rails 10e (see FIG. 2, FIG. 4, and FIG. 6). The shaft 10n serves a part of a lock canceling mechanism that cancels prevention of movement of the rack 9 by the rack movement-preventing mechanism 10c when the rack tray 10 is placed on the rack collecting section 8C.

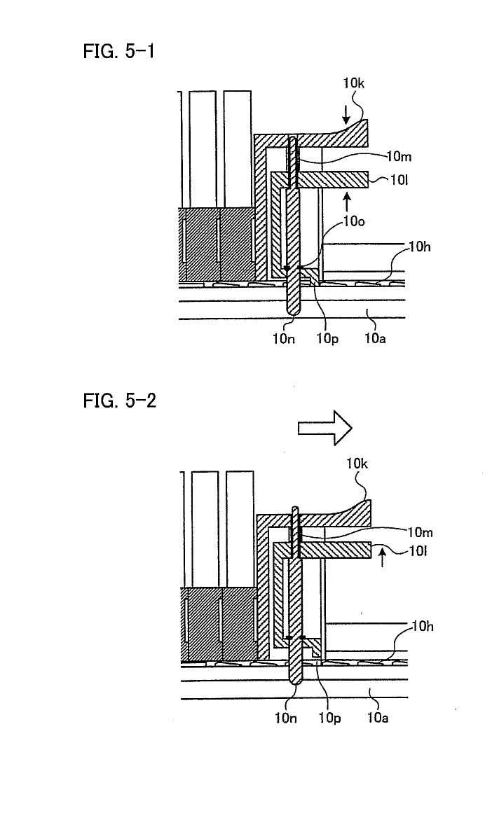

The engagement section 10h has a protruding shape, an inclination of a slope on the opening side in the traveling direction of the rack 9 is set to be high, and an inclination of the other slope is set to be low. For this reason, in order to move the rack movement-preventing mechanism 10c on the opening side in the traveling direction, the partition 10k or the partition 10l serving as a handle section may be pushed. However, when the partition 10k or the partition 10l is pushed in the opposite direction, the rack movement-preventing mechanism 10c cannot be moved to the rear side of the opening opposing the traveling direction, and backward movement is locked since the inclination of the engagement section 10h on the opening side is high. In order to move the rack movement-preventing mechanism 10c in a forward or backward direction, as shown in FIG. 5-1, the partition 10k and the partition 10l serving as handle sections are gripped from the upper and lower sides and pushed. In this manner, the partition 10l is pushed up. When the partition 10l is pushed up, as shown in FIG. 5-2, the projection 10p at the distal end of the partition 10l rises. When the partition 10l is pushed up, the engagement between the projection 10p of the rack movement-preventing mechanism 10c and the engagement section 10h on the guide rail 10e is canceled to make it possible to move the rack movement-preventing mechanism 10c to the rear side of the opening. The rack 9 held and stored on the rack tray 10 is prevented by the rack dropout-preventing mechanism 10b and the rack movement-preventing mechanism 10c from moving in a forward or backward direction and prevented by the opposite guide walls 10f of the rack tray 10 from longitudinal moving. However, since the upward movement is not inhibited, a part of the rack 9 is pulled up to make it possible to freely pick any one of the racks 9 to be stored from an arbitrary position of the rack tray 10 without moving the rack movement-preventing mechanism 10c, and the rack 9 can be very easily taken in or out.

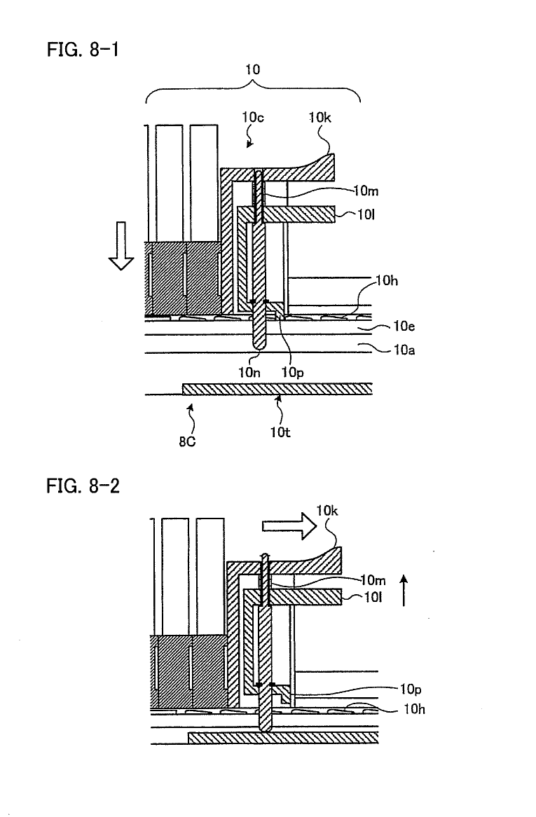

A lock canceling mechanism of the rack movement-preventing mechanism 10c will be described below with reference to FIG. 7, FIG. 8-1, and FIG. 8-2. FIG. 7 is a perspective view of the rack collecting section 8C. FIGS. 8-1 and 8-2 are operational diagrams of lock cancellation of the rack movement-preventing mechanism 10c. When the rack tray 10 is set on the rack collecting section 8C to collect the rack 9, the locked rack movement-preventing mechanism 10c hinders the rack 9 from being collected. Therefore, in order to save a trouble of manually moving the rack movement-preventing mechanism 10c, the lock canceling mechanism of the rack movement-preventing mechanism 10c is arranged. As shown in FIG. 7, on the rack collecting section 8C, a push-up section 10t serving as a lock canceling mechanism of the rack movement-preventing mechanism 10c together with the shaft 10n and the push-up section 10u serving as a lock canceling mechanism of the rack dropout-preventing mechanism 10b are formed. The push-up section 10t is a narrow protrusion formed at a center section of the rack collecting section 8C in parallel to the rack traveling direction. As shown in FIG. 8-1, when the rack tray 10 is arranged on the rack collecting section 8C, the shaft 10n extending to the lower section of the guide rail 10e is brought into contact with the push-up section 10t on the rack collecting section 8C and pushed up. When the shaft 10n is pushed up, the partition 10l fixed to the shaft 10n is also pushed up. For this reason, as shown in FIG. 8-2, the projection 10p at the distal end of the partition 10l is lifted up to cancel the engagement with the engagement section 10h on the guide rail 10e. With the lock cancelling mechanism of the rack movement-preventing mechanism 10c, the rack movement-preventing mechanism 10c can be moved in a direction opposing the opening without gripping and pressing the partition 10k and the partition 10l serving as the handle sections from the upper and lower sides. In this manner, when the rack 9 is pushed to the rack collecting section 8C side with a push lever of the transport mechanism 8B, the unlocked rack movement-preventing mechanism 10c is also moved in the direction opposing the opening of the rack tray 10 together with the rack 9.

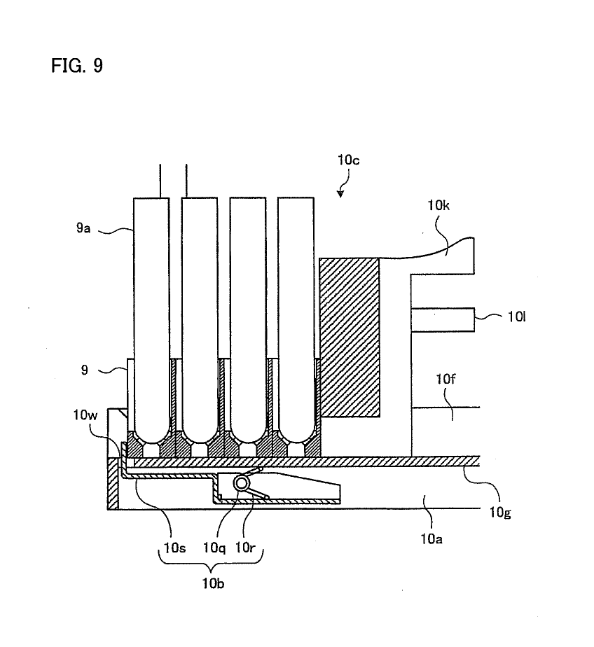

The rack dropout-preventing mechanism 10b will be described below with reference to the drawings. FIG. 9 is a cross-sectional view of the rack tray 10 in FIG. 3 along a B-B line. As shown in FIG. 9, the rack dropout-preventing mechanism 10b has a dropout-preventing lever 10s that prevent the rack 9 from being dropped out of the opening. The planar dropout-preventing lever 10s which is formed in a staircase pattern horizontally extends under the substrate 10g and is bent from a hole 10w (see FIG. 2) formed near the opening and vertically rises up to prevent the rack 9 from being dropped out. The dropout-preventing lever 10s is supported on the substrate 10g of the tray base 10a with a shaft 10q, a spring 10r is set between the bottom surface of the substrate 10g and the dropout-preventing lever 10s to upwardly bias an end section of the dropout-preventing lever 10s rising up from the hole 10w. In FIG. 9, although a coil spring is used as the spring 10r, a leaf spring, a tension spring, or the like may be used.

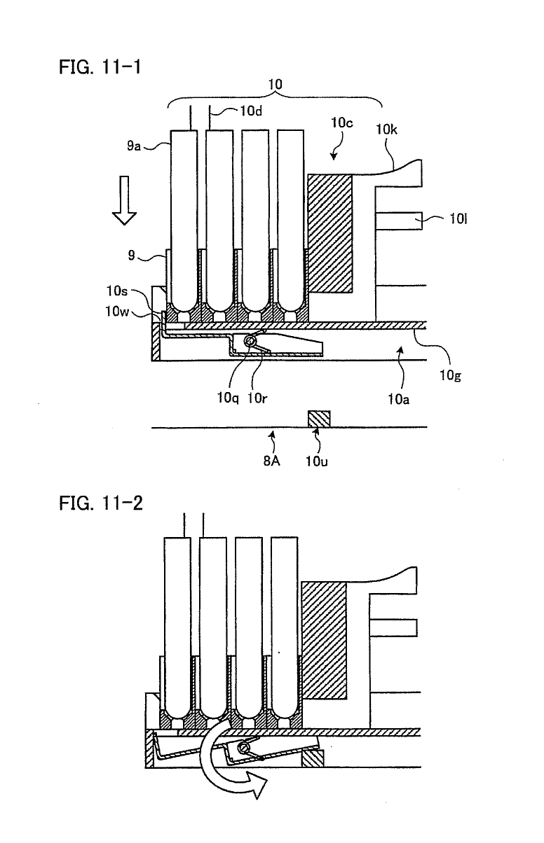

With reference to FIG. 10, FIG. 11-1, and FIG. 11-2, the lock canceling mechanism of the rack dropout-preventing mechanism 10b will be described below. FIG. 10 is a perspective view of a rack tray set section 8A. FIGS. 11-1 and FIG. 11-2 are operational diagrams of lock cancellation of the rack dropout-preventing mechanism 10b. As shown in FIG. 10, on the rack tray set section 8A, the push-out lever 8a that pushes out the rack 9 on the transport mechanism 8B side and the push-up section 10u serving as the lock canceling mechanism of the rack dropout-preventing mechanism 10b are formed. The push-up section 10u is a projection formed on the rack tray set section 8A on the opening side. In Embodiment 1, since the rack dropout-preventing mechanisms 10b are formed at two positions (left and right), the push-up sections 10u are also formed at two positions. The push-out lever 8a is built in the rack tray set section 8A before the rack tray 10 is arranged, and travels through the trench 8b and the trench 10j of the rack tray 10 after the rack tray 10 is arranged, to push out the rack 9 on the opening side. As shown in FIG. 11-1, when the rack tray 10 is set on the rack tray set section 8A, an end section of the dropout-preventing lever 10s horizontally extending under the substrate 10g is brought into contact with the push-up section 10u on the rack tray set section 8A. The end section of the dropout-preventing lever 10s is pushed up by the push-up section 10u with the contact, and the other end of the dropout-preventing lever 10s is pushed down by using the shaft 10q as a rotating axis. In this manner, as shown in FIG. 11-2, the dropout-preventing lever 10s vertically rising from the hole 10w formed in the opening is pulled down to cancel the locked state. The push-out lever 8a built in the rack tray set section 8A is traveled to push out the rack 9 to the transport mechanism 8B, and the transport mechanism 8B transports the rack 9 to the specimen dispenser 20. In Embodiment 1, the rack tray set section 8A does not include the push-up section 10t serving as the lock canceling mechanism of the rack movement-preventing mechanism 10c. However, when the partition 10k of the rack movement-preventing mechanism 10c is only slightly pushed, the rack movement-preventing mechanism 10c can be moved. For this reason, the rack tray set section 8A may include the push-up section 10t.

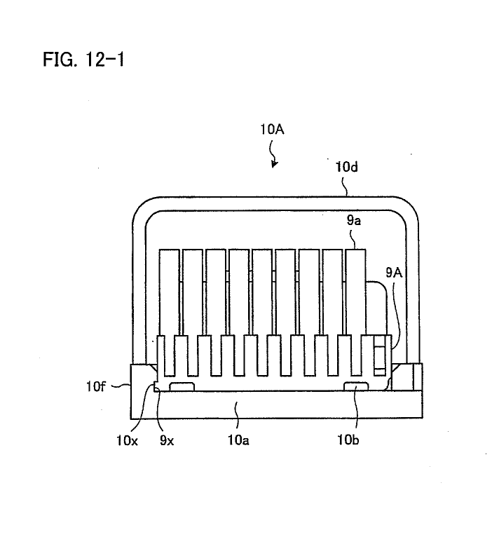

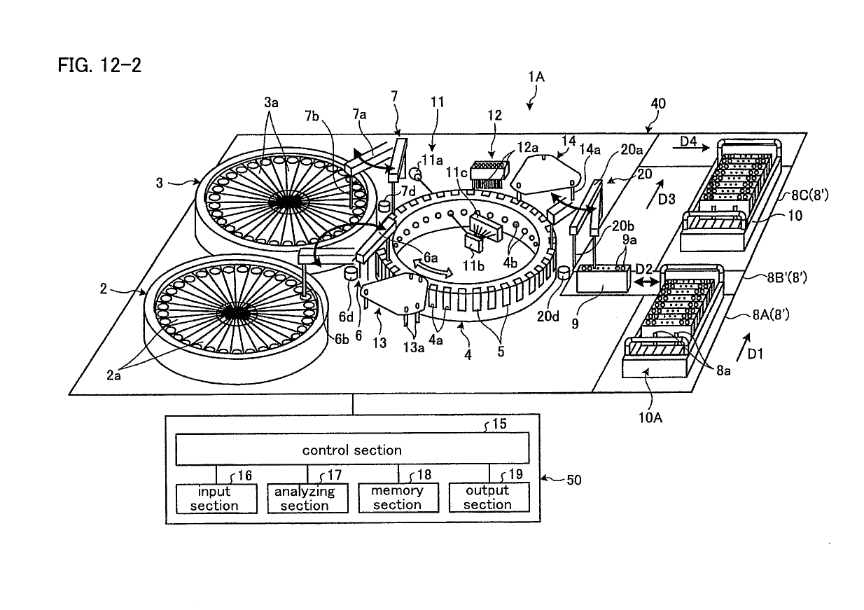

As a modification of the rack tray 10 according to Embodiment 1, as shown in FIG. 12-1, a rack tray 10A in which a side surface section, being in contact with a rack 9A, of the guide wall 10f of any one of the two sides parallel to the traveling direction of the rack 9 is hollowed out to form a fitting section 10x on the side surface section is illustrated. The fitting section 10x is formed on an entire lower section of the side surface being in contact with the substrate 10g of the guide wall 10f. On the rack tray 10A, the rack 9A having a projection section 9x fitted in the fitting section 10x is preferably stored. The rack tray 10A and the rack 9A are fitted through the fitting section 10x and the projection section 9x to make it possible to more stably transport the rack tray and set the rack tray in the apparatus. The fitting section 10x prevents the rack 9 from falling and moving together with the rack movement-preventing mechanism 10c. In FIG. 12-1, the fitting section 10x is a rectangular recessed section, and the projection section 9x is a rectangular projection section fitted in the recessed section. The fitting section 10x and the projection section 9x need only be fitted in each other, and trapezoidal shapes or the like may be employed. In use of the rack 9A and the rack tray 10A shown in FIG. 12-1, an automatic analyzing apparatus 1A including a rack transport system 8′ as shown in FIG. 12-2 is used. Since the rack 9A and the rack tray 10A are horizontally asymmetrical because the projection section 9x and the fitting section 10x are formed, the rack 9A cannot be easily collected in the rack collecting section 8C when the rack trays 10A in the rack tray set section 8A and the rack collecting section 8C are faced. Therefore, when the rack 9A and the rack tray 10A are used, as shown in FIG. 12-2, the arrangements of the rack tray set section 8A and the rack collecting section 8C need to be changed to change the rack transport system such that the rack trays 10A are arranged in the same direction. As another modification, a rack tray 10B shown in FIG. 13 is illustrated. In the rack tray 10B, a rack movement-preventing mechanism 10c′ does not have the shaft 10n, and inclinations of two slopes of the engagement section 10h′ on the guide rail 10e are set to be equal to each other. When the inclinations of the slopes are set to be equal to each other, the rack movement-preventing mechanism 10c′ can be moved in the forward or backward directions with the same force. When the rack 9 is pushed with a push-out lever (not shown) of the transport mechanism 8B, the projection 10p runs on the engagement section 10h′ to make it possible to cancel the locked state.

In Embodiment 1, on the basis of FIG. 1, the rack transport system 8 having one rack tray set section 8A and one rack collecting section 8C has been described. However, the number of rack tray set sections and the number of rack collecting sections need only be equal to each other, the system may have two or more rack tray set sections and two or more rack collecting sections. Furthermore, in FIG. 1, the automatic analyzing apparatus having the rack transport system 8 arranged on the right of the specimen dispenser 20 is illustrated. However, various modifications, made without departing from the object of the present invention, such as a rack transport system in which the rack tray set section 8A is arranged near and on the right of the specimen dispenser 20, the rack collecting section 8C is arranged on the left and the transport mechanism 8B is arranged in the lower section of the analyzing apparatus such that the rack tray set section 8A is connected to the rack collecting section 8C can be used.

### Embodiment 2

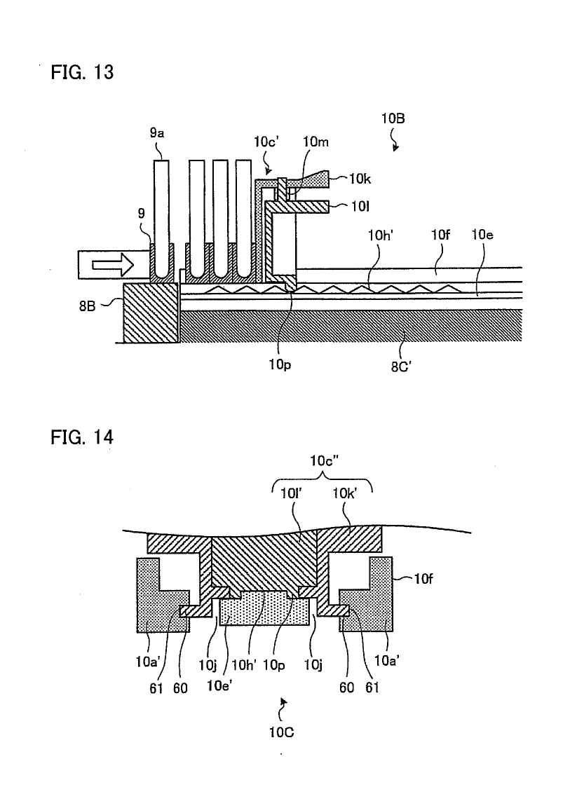

A rack tray and a rack transport system according to Embodiment 2 of the present invention will be described below with reference to the drawings. FIG. 14 is a cross-sectional view of an engagement section including a rack movement-preventing mechanism 10c″ and a guide rail 10e′. FIG. 15-1 and FIG. 15-2 are sectional views showing a rack tray 10C according to Embodiment 2 together with the rack 9 and a rack collecting section 8C′. The rack tray 10C according to Embodiment 2 is considerably different from that of Embodiment 1 in that the guide rail 10e′ is formed independently of the tray base. As shown in FIG. 14, the rack movement-preventing mechanism 10c″ does not have a shaft 10n (see FIG. 4). Therefore, the guide rail 10e′ does not have the trench 10i through which the shaft 10n passes, and one engagement section 10h′ is arranged at each position of the guide rail 10e′. The partition 10k′ includes a projection 60 at the distal end thereof such that the partition 10k′ is supported by a tray base 10a′ not the guide rail 10e′, and the projection 60 is engaged with an engagement section 61 formed on the tray base 10a′. As shown in FIG. 14, the guide rail 10e′ according to Embodiment 2 is formed independently of the tray base 10a′ and jointed to the tray base 10a′ through a joint member 30. A spring 33 that biases to rise up the guide rail 10e′ is arranged between the joint member 30 and the guide rail 10e′. The guide rail 10e′ is jointed to the joint member 30 by the joint section 31 and supported on the tray base 10a′ by a shaft 32 serving as a joint section between the joint member 30 and the tray base 10a′. The shape of the engagement section 10h′ on the guide rail 10e′ and the engagement between the engagement section 10h′ and the projection 10p of the partition 10l′ are the same as those in Embodiment 1 except that one engagement section 10h′ is formed at each position on the guide rail 10e′. The partition 10k′ or the partition 10l′ serving as a handle section is pushed to make it possible to move the rack movement-preventing mechanism 10c″ to the opening side. However, movement in the opposite direction cannot be done until the partition 10k′ and the partition 10l′ are gripped and pressed from the upper and lower sides to cancel the engagement of the engagement section 10h′ and the projection 10p. A description of the rack dropout-preventing mechanism 10b is omitted. However, the rack tray 10C includes the rack dropout-preventing mechanism 10b as in Embodiment 1.

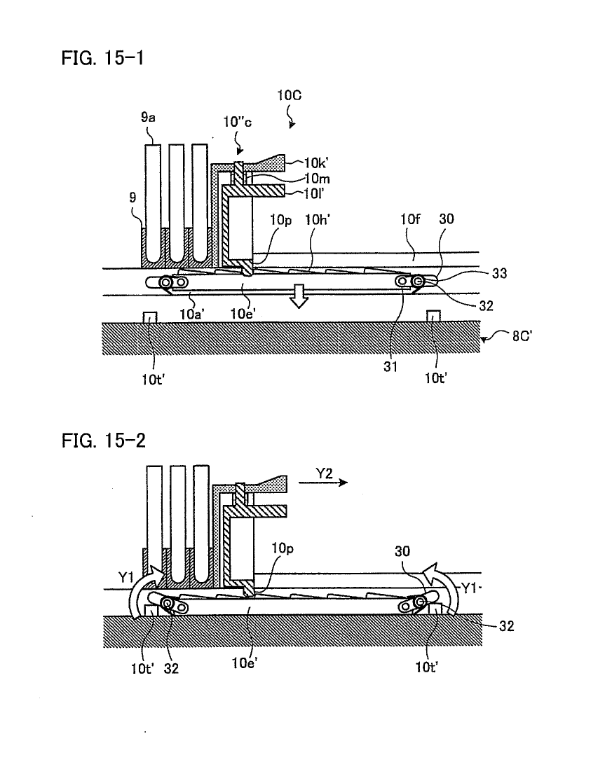

A rack transport system using the rack tray 10C according to Embodiment 2 will be described below. The rack transport system using the rack tray 10C, like the rack transport system according to Embodiment 1, includes a rack tray set section, a transport mechanism, and a rack collecting section. However, the rack collecting section 8C′ according to Embodiment 2, as shown in FIG. 15-1, includes a push-up section 10t′ that pushes up the joint member 30 of the rack tray 10C to push down the guide rail 10e′. The push-up section 10t′ is arranged on the rack collecting section 8C′ under the joint member 30. As shown in FIG. 15-1, when the rack tray 10C is arranged in the rack collecting section 8C′ from above, the push-up section 10t′ is brought into contact with the joint member 30, as indicated by an arrow Y1 in FIG. 15-2, the push-up section 10t' pushes up the joint member 30 from the outside. With the push-up operation, the joint member 30 rotates by using the shaft 32 as a rotating axis to push down the guide rail 10e′. When the guide rail 10e′ is pushed down, the engagement between the projection 10p at the distal end of the partition 10l′ and the engagement section 10h is canceled to make it possible to move the rack movement-preventing mechanism 10c″ in a backward direction (indicated by an arrow Y2).

### INDUSTRIAL APPLICABILITY

As described above, a rack tray, a rack, and a rack transport system according to the present invention are effectively used in an automatic analyzing apparatus that optically measures a reaction between a specimen and a reagent to analyze components of the specimen, and in particular, are suitable for safe transport and setting in the apparatus when a plurality of racks supporting substance containers are arranged.

1. A rack tray that arranges and holds a plurality of racks supporting a plurality of specimen containers, characterized by comprising:
a tray base that stores the plurality of racks;
a rack dropout-preventing mechanism that projects from an opening of the rack tray to prevent the racks from being dropped out when the racks are stored on the tray base; and
a rack movement-preventing mechanism that moves on the tray base to press the plurality of racks arranged on the tray base to a side of the rack dropout-preventing mechanism.

2. The rack tray according to claim 1, characterized by comprising a guide rail having a plurality of engagement sections at positions corresponding to the number of racks held and stored on the tray base, wherein a locking section held by the rack movement-preventing mechanism is engaged with the engagement section to lock the movement of the rack.

3. The rack tray according to claim 2, characterized in that the engagement section is a projection formed on the guide rail, an inclination of a slope on a side of the rack tray opening is set to be high, and an inclination of the other slope is set to be low.

4. The rack tray according to claim 2, characterized in that the rack movement-preventing mechanism includes a handle section that pushes up the locking section, the handle section is gripped and pushed to push up the locking section to cancel the engagement with the engagement section, and the rack movement-preventing mechanism is moved.

5. The rack tray according to claim 1, characterized by comprising grip members on two opposite sides parallel to an arrangement direction of the racks stored on the tray base.

6. The rack tray according to claim 4, characterized in that the rack movement-preventing mechanism includes a shaft supported by the handle section and extending to a lower section of the guide rail, and the guide rail includes a trench section through which the shaft passes with movement of the rack movement-preventing mechanism.

7. The rack tray according to claim 2, characterized in that the guide rail is formed independently of the tray base, jointed to the tray base by a joint member, and a spring that biases to push up the guide rail is arranged between the joint member and the guide rail.

8. The rack tray according to claim 1, characterized in that the tray base includes guide walls on three sides except for the opening in the rack traveling direction, and the guide wall of any one of two sides parallel to the traveling direction has a fitting section fitted on the rack formed on a side surface thereof.

9. The rack tray according to claim 8, characterized in that a rack having a projection section that is fitted in the fitting section of the guide wall is held and stored.

10. The rack tray according to claim 5, characterized in that the grip member arranged on the opening side of the rack in the traveling direction is arranged such that the holding section is offset from an arrangement position of the grip member.

11. A rack transport system comprising:
a rack tray set section on which a rack tray, according to claim 1, that arranges and holds the plurality of racks supporting a plurality of specimen containers is placed;
a rack collecting section on which an empty rack tray according to claim 1 is placed and which collects a rack supporting a plurality of specimen containers that are dispensed; and
a transport mechanism that transports the rack from the rack tray set section to a dispensing mechanism, dispenses specimens from all the specimen containers, and thereafter transports the rack to the rack collecting section.

12. The rack transport system according to claim 11, characterized in that the rack collecting section includes a lock canceling mechanism of a rack movement-preventing mechanism of the rack tray.

13. The rack transport system according to claim 12, characterized in that the lock canceling mechanism is a push-up member that pushes up a shaft of the rack tray.

14. The rack transport system according to claim 12, characterized in that the lock canceling mechanism is a push-up member that pushes up a joint member of the rack tray such that the guide rail of the rack tray is pushed down.

15. The rack transport system according to claim 11, characterized in that the rack tray set section and the rack collecting section include a lock canceling mechanism of a rack dropout-preventing mechanism of the rack tray.

16. A rack that is held and stored on a rack tray according to claim 1, characterized by comprising a projection section that is fitted in a fitting section of a guide wall of a tray base.
